(19) United States
(12) Patent Application Publication
(10) Pub. No.: US 2026/0311302 A1
(43) Pub. Date: Oct. 8, 2026

(54) HEURISTIC ADAPTIVE IMAGE QUALITY DETECTION AND IMPROVEMENT FOR VIDEO SEE-THROUGH MIXED REALITY

(71) Applicant: Samsung Electronics Co., Ltd., Suwon-si (KR)

(72) Inventor: Yingen Xiong, Mountain View, CA (US)

(21) Appl. No.: 19/568,592

(22) Filed: Mar. 16, 2026

Related U.S. Application Data
(60) Provisional application No. 63/785,361, filed on Apr. 8, 2025.

(51) Int. Cl. G06T 5/70; G06F 3/01; G06T 7/00; G06V 10/764; G06V 10/98

(52) U.S. Cl. CPC G06T 5/70; G06F 3/013; G06T 7/0002; G06T 2207/30168; G06V 10/764; G06V 10/993

(57) ABSTRACT

A method includes capturing an image with an external camera of a device, the image having a number of image quality features, determining from the image, using a processor, a regional image quality map corresponding to each image quality feature and global image quality features, determining, using the processor, at least one criterion corresponding to each image quality feature, for each image quality feature, classifying, using the processor, the image into a quality category based on a comparison of the corresponding regional image quality map to the corresponding at least one criterion, determining, using the processor, an image enhancement algorithm based on the quality categories, determining, using the processor, adaptive parameters for the image enhancement algorithm based on the regional image quality maps and the global image quality features, enhancing, using the processor, the image with the image enhancement algorithm using the adaptive parameters, and displaying the enhanced image.

### CROSS-REFERENCE TO RELATED APPLICATION AND PRIORITY CLAIM

This application claims priority under 35 U.S.C. § 119 (e) to U.S. Provisional Patent Application No. 63/785,361 filed on Apr. 8, 2025, which is hereby incorporated by reference in its entirety.

### TECHNICAL FIELD

This disclosure relates generally to image processing. More specifically, this disclosure relates to systems and methods for improving pass-through image quality in real time for a mixed reality device.

### BACKGROUND

Wearable mixed reality (MR) technology has diverse applications in the daily lives of users. As users continue to adopt this technology the image quality of the pass-through or see-through video of mixed reality devices is becoming more important since it directly affects the user experience with—and the continued adoption of—the technology.

### SUMMARY

This disclosure relates to heuristic adaptive image quality detection and improvement for mixed reality (MR) devices.

In a first embodiment, a method includes capturing an image with an external camera of a device, the image having a number of image quality features, determining from the image, using a processor of the device, a regional image quality map corresponding to each image quality feature and global image quality features, determining, using the processor, at least one criterion corresponding to each image quality feature, for each image quality feature, classifying, using the processor, the image into a quality category based on a comparison of the corresponding regional image quality map to the corresponding at least one criterion, determining, using the processor, an image enhancement algorithm based on the quality categories, determining, using the processor, adaptive parameters for the image enhancement algorithm based on the regional image quality maps and the global image quality features, enhancing, using the processor, the image with the image enhancement algorithm using the adaptive parameters, and displaying the enhanced image.

In a second embodiment, an electronic device includes an external camera, at least one display, and a processor operably coupled to the external camera and the at least one display. The external camera is configured to capture an image having a number of image quality features. The processor is configured to determine from the image a regional image quality map corresponding to each image quality feature and global image quality features and to determine at least one criterion corresponding to each image quality feature. For each image quality feature, the processor is configured to classify the image into a quality category based on a comparison of the corresponding regional image quality map to the corresponding at least one criterion. The processor is additionally configured to determine an image enhancement algorithm based on the quality categories, to determine adaptive parameters for the image enhancement algorithm based on the regional image quality maps and the global image quality features, and to enhance the image with the image enhancement algorithm using the adaptive parameters. The at least one display is configured to display the enhanced image.

Any single one or any combination of the following features may be used with the first or second. A user foveation region may be determined within the image based on data from eye tracking sensors of the device, wherein the regional image quality maps and the global image quality features are determined from the foveation region of the image. Pass-through transformation may be performed on the enhanced image to generate a pass-through image that matches a viewpoint of the user's eyes, wherein displaying the enhanced image comprises displaying the pass-through image. The image quality features may include brightness, contrast, and signal-to-noise ratio (SNR). Classifying the image into the quality category for each image quality feature can include classifying the image into a brightness quality category, a contrast quality category, and an SNR quality category, and the image enhancement algorithm can be determined based on the brightness quality category and the contrast quality category. Enhancing the image further can include performing noise reduction based on the SNR quality category. The adaptive parameters can include a brightness control parameter and a contrast control parameter, and determining the adaptive parameters can include selecting an algorithm for determining the brightness control parameter based on the brightness quality category and selecting an algorithm for determining the contrast control parameter based on the contrast quality category. The image enhancement algorithm can be a Gamma function or an affine function, and the adaptive parameters can be parameters of the Gamma function or the affine function. For each image quality feature, determining the corresponding regional image quality map can include determining a regional image quality value for each pixel of the image as a function of pixel values of all pixels within a window centered on the pixel. The regional image quality maps can include a regional brightness map, a regional contrast map, and a regional SNR map, determining the regional brightness map can include determining a regional brightness value for each pixel of the image as a mean of the pixel values of all pixels within the window, determining the regional contrast map can include determining a regional contrast value for each pixel of the image as a standard deviation of the pixel values of all pixels within the window, and determining the regional SNR map can include determining a regional SNR value for each pixel of the image as a logarithmic function of the mean and the standard deviation of the pixel values of all pixels within the window.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an overview of an example heuristic adaptive image quality detection and improvement system in accordance with this disclosure;

FIGS. 3A and 3B illustrate an example process flow for heuristic adaptive image quality detection and improvement for video see-through MR in accordance with this disclosure;

FIG. 4 illustrates an example of a moving window calculation used for dynamically determining regional image quality feature maps in accordance with this disclosure;

FIGS. 5A and 5B illustrate an example process flow for classifying image quality types of see-through frames and heuristically improving image quality in video see-through MR in accordance with this disclosure;

FIG. 6 illustrates an example method for providing heuristic adaptive image quality detection and improvement for MR devices in accordance with this disclosure; and

FIG. 7 illustrates a comparison of video see-through image frames before and after heuristic adaptive image quality detection and improvement in accordance with this disclosure.

### DETAILED DESCRIPTION

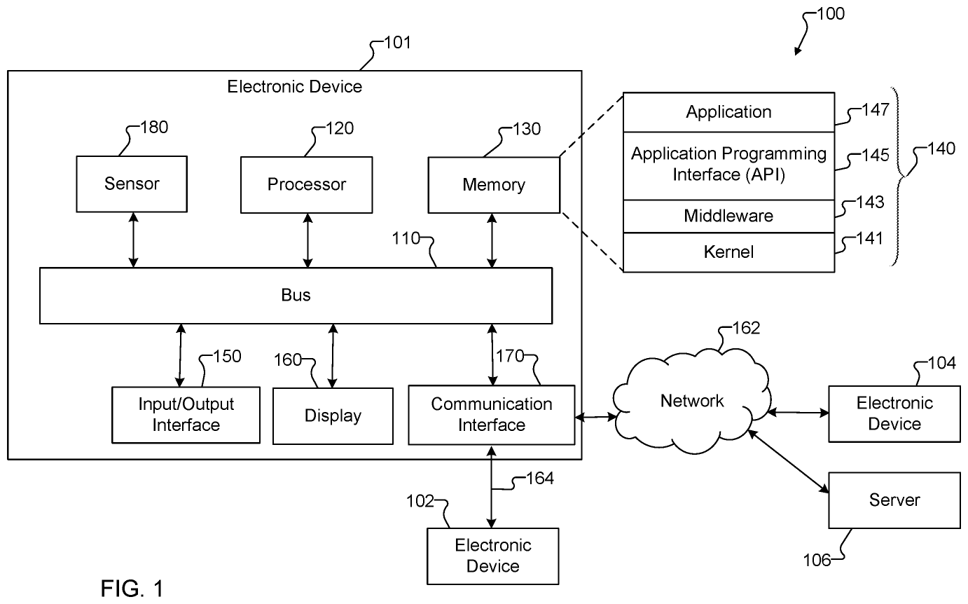

FIGS. 1-7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

Wearable mixed reality (MR, or XR) devices include head-mounted devices (HMDs) such as augmented reality (AR) glasses and virtual reality (VR) headsets with pass-through (or see-through) video capabilities. Such devices may be referred to as video see-through (VST) MR devices. As noted above, the image quality of the pass-through video directly impacts the entire MR user experience.

Image brightness, image contrast, and image signal-to-noise ratio (SNR) are important properties of image visual quality (or simply image quality). See-through frames with good brightness, good contrast, and good SNR allow the user to perceive their surroundings well. See-through frames with poor image visual quality may give the user an inaccurate perception of their surroundings, leading to a poor user experience, and may even cause the user to experience motion sickness.

See-through frames of a VST MR device captured in different environments have different image visual qualities. For example, see-through frames captured in a low-light environment may have low brightness and may be noisy, while see-through frames captured in a high-light environment may be too bright. In some other environments, the see-through frames may be blurry and low contrast.

The present disclosure provides adaptive methods to heuristically improve image visual quality by verifying and improving image brightness, image contrast, and image SNR. The disclosed methods create final pass-through frames with excellent image visual quality to provide a better user experience for VST MR devices.

For example, an embodiment of the present disclosure provides an efficient algorithm for heuristically detecting issues with the visual quality of see-through images, classifying the images into different quality categories, and correcting the detected issues with adaptive image visual quality enhancement approaches. This provides an efficient image visual quality enhancement model and adaptively computed parameters for the model using the information of the considered see-through frames. It enhances the visual quality for the frames with the created model. An embodiment of the invention can improve visual quality for the generated final view frames.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to heuristic adaptive image quality detection and improvement for an MR HMD. For example, as described below, the processor 120 may receive and process inputs (such as camera images and sensor inputs), determine image quality features, classify the image into a quality category based on the image quality features, adaptively determine parameters for image enhancement according to the quality category, and heuristically enhance the image with the parameters. The processor 120 may also instruct other devices to perform certain operations or display content on one or more displays 160.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to a heuristic adaptive image quality detection and improvement for an MR HMD. For example, the application 147 includes one or more applications supporting the receiving and processing of inputs (such as camera images and sensor inputs), determination of image quality features, classification of the image into a quality category based on the image quality features, adaptive determination of parameters for image enhancement according to the quality category, and heuristic enhancement of the image with the parameters. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. In some embodiments, the server 106 may perform various operations related to heuristic adaptive image quality detection and improvement for an MR HMD. For example, the server 106 may receive and process inputs (such as camera images and sensor inputs), determine image quality features, classify the image into a quality category based on the image quality features, adaptively determine parameters for image enhancement according to the quality category, and heuristically enhance the image with the parameters. The server 106 may also instruct other devices to perform certain operations or display content on one or more displays 160. The server 106 may further receive inputs (such as data samples to be used in training machine learning models) and manage such training by inputting the samples to the machine learning models, receive outputs from the machine learning models, and execute learning functions (such as loss functions) to improve the machine learning models.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

For simplicity, embodiments of the present disclosure are described as being performed by an electronic device 101 which is an MR HMD. However, the embodiments of the present disclosure could be implemented on any other suitable device, such as an MR HMD system that comprises multiple devices, e.g., a smart phone (an electronic device 101) inserted into an HMD frame (an electronic device 102) that converts the smartphone into an MR display. It is understood that references to electronic device 101 or an MR HMD herein below are not intended to limit the present disclosure to any particular implementation of an MR display.

For ease of explanation, the systems of the below figures are described as being implemented using the electronic device 101 in the network configuration 100 of FIG. 1. However, the systems may be used with any other suitable device(s), such as the server 106, and in any other suitable system(s). The system detects and improves image quality for video see-through MR.

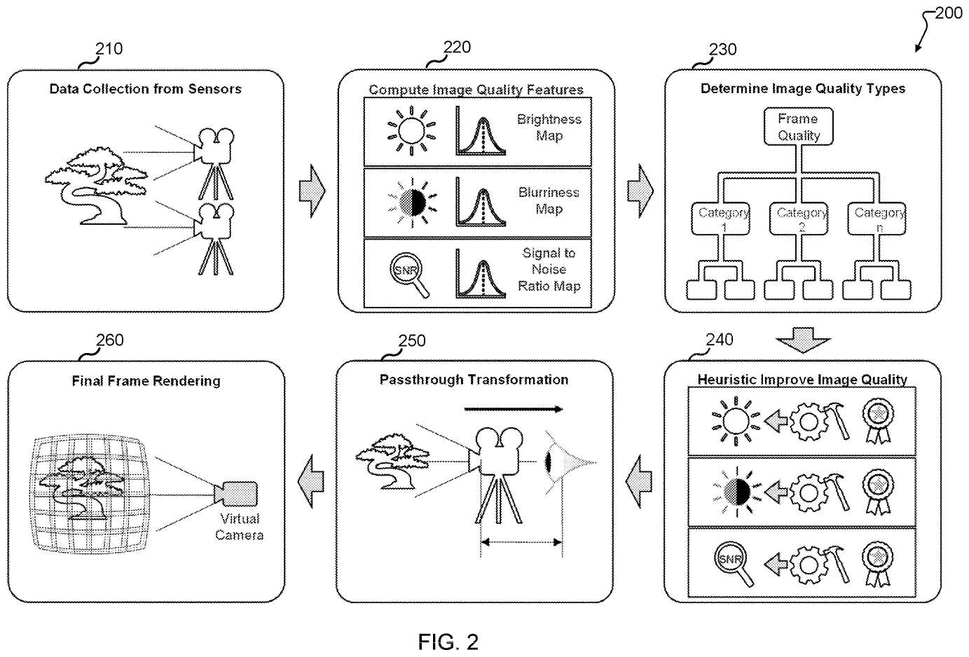

FIG. 2 illustrates an overview 200 of an example heuristic adaptive image quality detection and improvement system in accordance with this disclosure. As shown in FIG. 2, data is collected from data capture sensors (step 210). The collected data includes high-resolution see-through frames, depth data, eye tracking data, and head pose data. Next the system computes image quality features including image brightness maps, image blurriness maps, and image signal to noise ratio maps for the see-through frames, then creates image quality criteria for these image quality features (step 220). The system classifies the see-through frame images into image quality categories according to the image quality features, allowing for improvement of image quality using different approaches for different image categories (step 230).

The system creates an image quality enhancement model with adaptively estimated parameters, then enhances the image quality of the see-through frames using the created model based on the image quality categories (step 240). The system performs pass-through transformation and generates final view frames with the enhanced-quality see-through frames (step 250). Finally, the system renders the generated final view frames and displays them to the MR display panels (step 260).

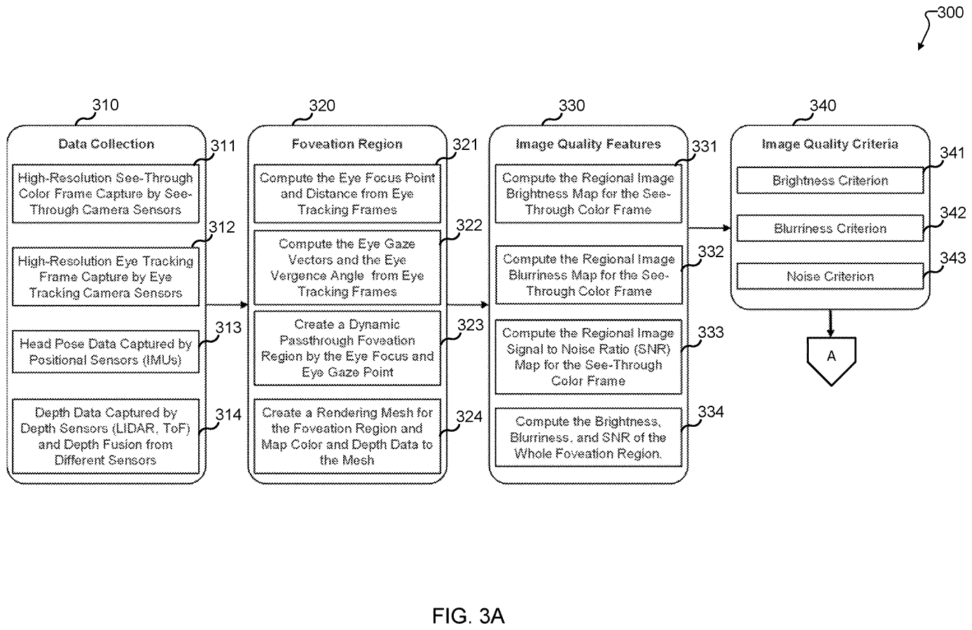

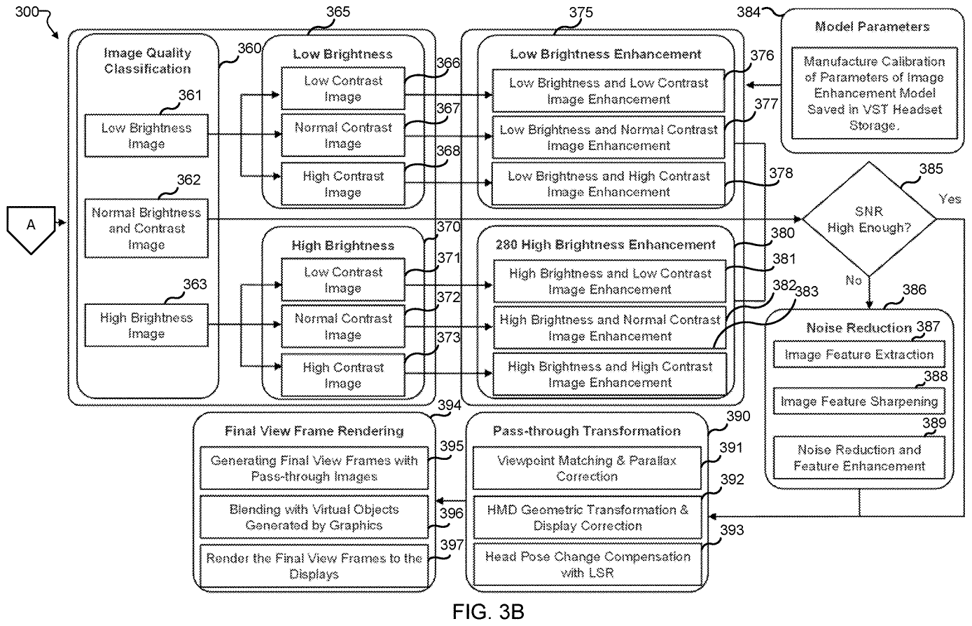

FIGS. 3A and 3B illustrate an example process flow 300 for heuristic adaptive image quality detection and improvement for video see-through MR in accordance with this disclosure. As shown in FIG. 3A, the process flow 300 It includes data collection 310, foveation region computations 320, image quality feature computations 330, image quality criteria creation 340. As shown in FIG. 3B, the process flow 300 continues with image classification 360, low brightness enhancement operations 375, high brightness enhancement operations 380, noise reduction 386, pass-through transformation 390, and final view frame rendering 394.

Referring now to FIG. 3A, in the process of data collection 310, the system (e.g., the MR HMD) captures high-resolution see-through color frames using see-through camera sensors (operation 311) and captures high-resolution eye tracking frames using eye tracking camera sensors (operation 312). The system extracts head pose data using positional sensors such as inertial measurement units (operation 313). The system captures and reconstructs depth data using depth sensors (e.g., LIDAR, time-of-flight sensors). These are source data for the inputs of the video see-through MR pipeline. The remainder of the process flow 300 may be performed on a frame-by-frame basis for each of the see-through color frames captured in the process of data collection 310.

The foveation region computations 320 may include computing the eye focus point and distance from eye tracking frames (operation 321), computing eye gaze vectors and eye vergence angle from eye tracking frames (operation 322), and creating a dynamic pass-through foveation region using the eye focus point and eye gaze vectors (operation 323). The system may additionally create a rendering mesh for the foveation region and maps color and depth data to the rendering mesh (operation 324). This allows the system to create an accurate pass-through transformation in the foveation region.

The image quality feature computations 330 may include computing a regional image brightness map (operation 331), regional image blurriness map (operation 332), and regional image signal-to-noise ratio map (operation 333) for the see-through color frame. The system may also compute an image brightness, image blurriness, and signal-to-noise ratio of the whole foveation region (operation 334) of the frame.

In the process of image quality criteria creation 340, the system may create criteria for classifying the images into categories by image quality. The criteria may include the brightness criterion 341, blurriness criterion 342, and noise criterion 343. The brightness criterion is used for determining the level of image brightness. The blurriness criterion is used for determining the level of image blurriness or image contrast (which is inversely related to blurriness). The noise criterion is used for determining the level of image noise.

The system is able to classify the image into quality categories by applying the appropriate image quality criteria to the regional image brightness map, regional image blurriness map, and regional image SNR map. For example, referring now to FIG. 3B, in the process of image classification 360 the system may first classify the image into the category of a low brightness image 361, normal brightness image 362, or high brightness image 363 by comparing the regional image brightness map to the image brightness criterion. The system may further classify the image into detailed categories 365 for the low brightness image 361 and detailed categories 370 for the high brightness image 363 by comparing the regional image blurriness map to the image blurriness criterion The detailed categories 365 include low brightness and low contrast image 366, low brightness and normal contrast image 367, low brightness image and high contrast image 368, while the detailed categories 370 include high brightness and low contrast image 371, high brightness and normal contrast image 372, and high brightness and high contrast image 373. In this example, the normal brightness image 362 is also a normal contrast image.

The low brightness enhancement operations 375 may improve the upon low image brightness with a low brightness enhancement approach and improve image contrast with different image contrast enhancement approaches for low contrast 376, normal contrast 377, and high contrast 378. The high brightness enhancement operations 380 may improve upon the high image brightness with a high brightness enhancement approach and improve image contrast with different image contrast enhancement approaches for low contrast 381, normal contrast 382, and high contrast 383. The model parameters 384 may be used to generate image quality enhancement models used for the image brightness enhancement approaches and the contrast enhancement approaches.

The system determines whether the SNR of the see-through frame is acceptably high at operation 385 by comparing the regional SNR map to the noise criterion. If the noise level is not acceptable, then the system may perform noise reduction to improve image quality (operation 386). The noise reduction operations 386 may include image feature extraction 387 and image feature sharpening 388 followed by noise reduction and feature enhancement 389.

After the noise levels are deemed acceptable at operation 385 or noise reduction operations 386 are completed the system may perform pass-through transformation operations 390. For example, the system may perform viewpoint matching and parallax correction for transforming the see-through frame from the see-through camera viewpoint to the eye viewpoint (operation 391). The system may also perform geometric transformation to account for the effects of the camera geometric pose and the eye geometric pose on the final view frame, and display correction for display lens geometric distortion correction and chromatic aberration correction (operation 392). The system may also compensate for head pose change caused by latencies of the see-through pipeline with, e.g., a lightweight super-resolution (LSR) approach (operation 393).

In the final view frame rendering operations 394, the system may generate the final view frames with the pass-through images (operation 395), blend the transformed see-through frames with virtual objects generated by graphics (operation 396), and finally render the final view frames to the display panels of the MR HMD (operation 397).

In performing the above example process flow 300, the system dynamically determines image quality features including a regional image brightness map, regional blurriness map, and regional signal-to-noise ratio map for image quality analysis and improvement for each see-through frame. The system also dynamically determines image quality types with image quality analysis and created image quality criteria based on local (e.g., regional) and global image quality features. The system then heuristically improves image quality with adaptive enhancement of image brightness and contrast and noise reduction using image feature enhancement models.

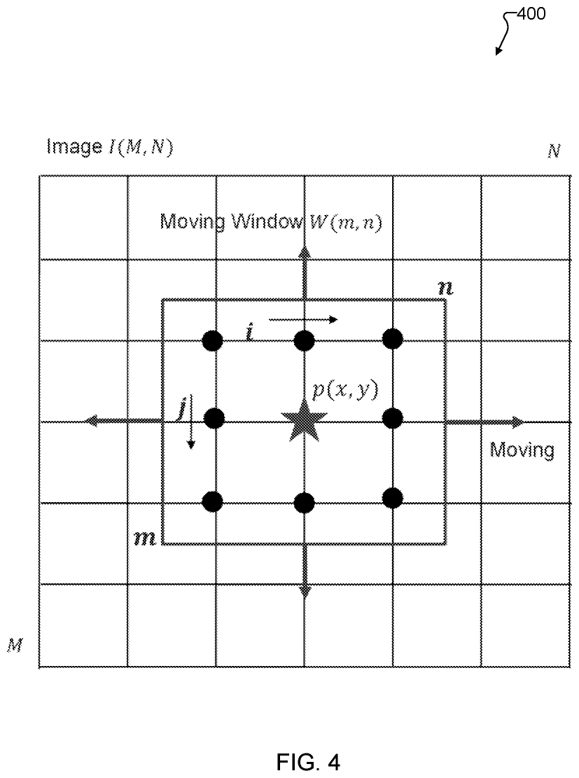

FIG. 4 illustrates an example 400 of a moving window calculation used for dynamically determining regional image quality feature maps in accordance with this disclosure. As noted above, systems of the present disclosure dynamically compute image quality features for image quality determination and improvement (e.g., as discussed in the example process flow 300 of FIGS. 3A and 3B). The moving window approach of example 400 may be used to generate different image quality feature maps, such as image brightness maps, image blurriness (or contrast) maps, and image SNR maps.

In example 400, I(M, N) is the input image of size M×N pixels and W(m, n) is the moving window of size m×n pixels. As illustrated in FIG. 4, the moving window is currently centered on a pixel p located at position (x, y). An image quality feature value may be determined for the pixel p in consideration of the pixels included in the moving window, after which the moving window may be shifted to another pixel and the image quality feature value for that pixel may be determined. Each image quality feature value determined in this way may be entered into a corresponding image quality feature map.

Example algorithms for generating brightness maps, blurriness maps, and SNR maps according to the example 400 are provided below. For simplicity, each of these example algorithms is disclosed as using the same moving window size. However, it is understood that the parameters of the moving window may be varied for different image quality feature calculations.

To generate a brightness map B, a brightness value B(x, y) of the considered pixel p(x, y) in the input image/may be calculated as the mean value of the pixels p(i, j)∈ [symbol] (p(x, y)) in the window W(m, n):

$$B ( x , y ) = \frac{1}{mn} {\sum }_{i = 0}^{m - 1} {\sum }_{j = 0}^{n - 1} I ( i , j ) \qquad ( 1 )$$

The window may be moved across the whole image to compute a brightness value for each pixel p by considering its neighboring pixels. After computing a brightness value for all pixels in the image, a brightness map for the whole image is obtained.

To generate a blurriness map C, a blurriness value C(x, y) of the considered pixel p(x, y) in the input image/may be calculated as the standard deviation of the pixels in the window W(m, n):

$$C ( x , y ) = {( \frac{1}{m n} {\sum }_{i = 0}^{m - 1} {\sum }_{j = 0}^{n - 1} {( I ( i , j ) - μ )}^{2} )}^{\frac{1}{2}} \qquad ( 2 )$$

The window may be moved across the whole image to compute a blurriness value for each pixel p by considering its neighboring pixels p(i, j)∈ [symbol] (p(x, y). After computing a blurriness value for all pixels in the image, a blurriness map for the whole image is obtained.

Blurriness is inversely proportional to contrast-a blurry image has low contrast while a sharp (or low-blurriness) image has high contrast. Accordingly, a contrast map D may be defined such that:

$$D ( x , y ) = \frac{1}{C ( x , y )} \qquad ( 3 )$$

To generate an SNR map S, a signal-to-noise ratio value S(x, y) of the considered pixel p(x, y) in the input image/may be calculated as follows based on the pixels in the window W(m, n):

$$S ( x , y ) = 10 {log}_{10} ( \frac{\frac{1}{m n} {\sum }_{i = 0}^{m - 1} {\sum }_{j = 0}^{n - 1} I ( i , j )}{\sqrt{\frac{1}{m n} {\sum }_{i = 0}^{m - 1} {\sum }_{j = 0}^{n - 1} {( I ( i , j ) - μ )}^{2}}} ) \qquad ( 4 )$$

The window may be moved across the whole image to compute an SNR value for each pixel p by considering its neighboring pixels p(i, j)∈ [symbol] (p(x, y)). After computing an SNR value for all pixels in the image, an SNR map for the whole image is obtained.

The system may create a noise criterion to determine whether the SNR of an image frame is acceptable (e.g., in operation 385 of example process flow 300), as follows:

$$S ( x , y ) \leq {T}_{s} \qquad ( 5 )$$

where Tₛ is a threshold SNR value. For a noisy image the system may perform noise reduction according to the noise type of the image. Noise reduction with edge preserving algorithms may be used to remove noise and keep image features simultaneously.

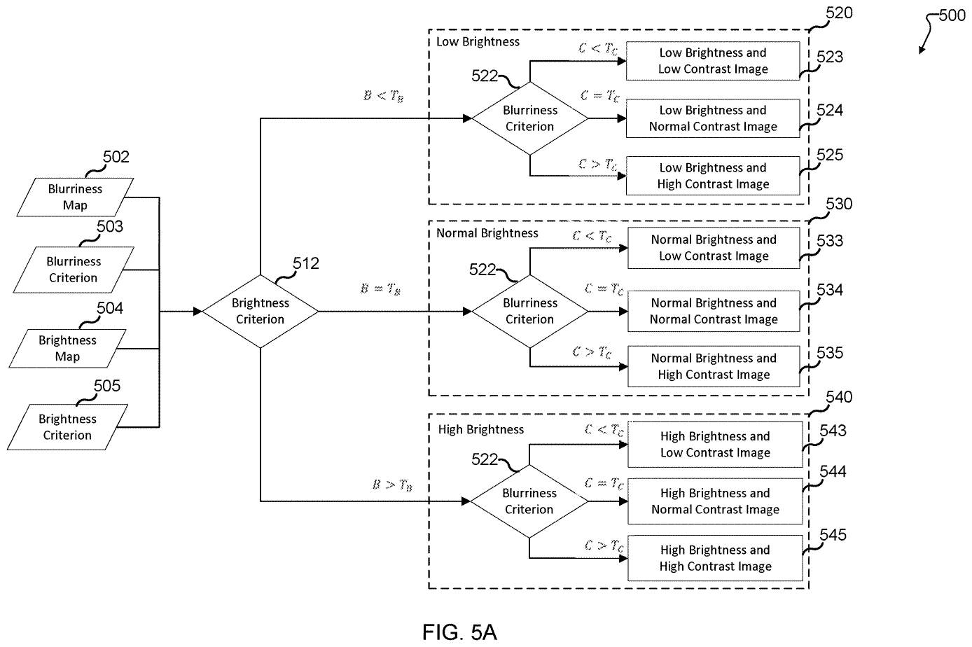

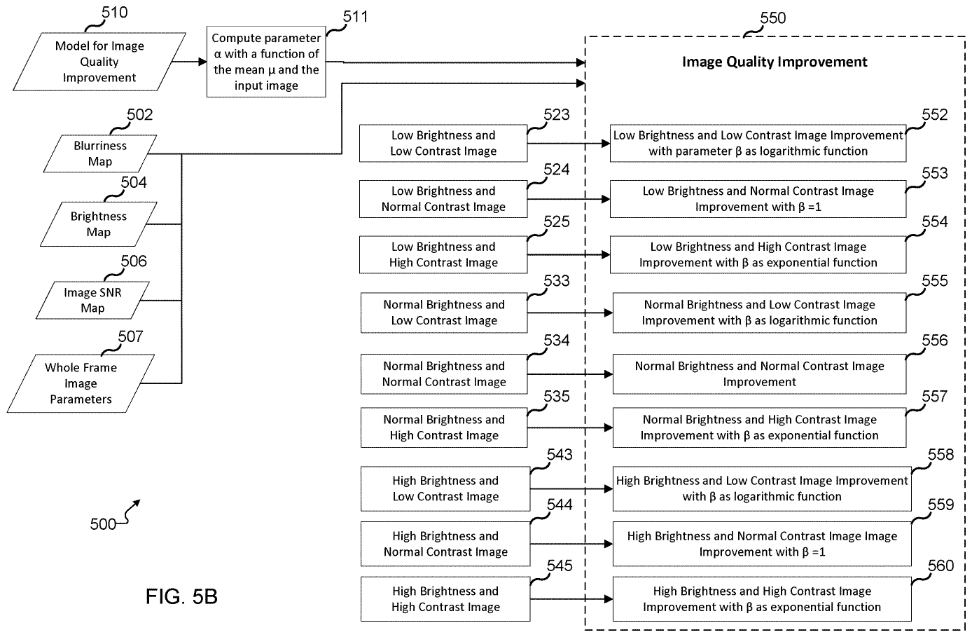

FIGS. 5A and 5B illustrate an example process flow 500 for classifying image quality types of see-through frames and heuristically improving image quality in video see-through MR in accordance with this disclosure. Referring to FIG. 5A, the process flow 500 works with high-resolution color frames Iᵢₙ obtained from camera sensors of the MR device (e.g., as discussed with respect to FIGS. 2 and 3A), and image quality features including an image blurriness map 502, blurriness criterion 503, image brightness map 504, brightness criterion 505, image signal-to-noise ratio map 506, and noise criterion. In this example noise reduction is not illustrated and may be performed as described in FIGS. 3A and 3B.

The brightness map 504 may be computed as discussed above (e.g., as B). The system may create a brightness criterion 505, used for classifying the image Iᵢₙ into a brightness category, as follows:

$${I}_{i n} = \{ \begin{matrix}{I}_{low - brightness} , & B ( x , y ) < {T}_{B} \\ {I}_{normal - brightness} , & B ( x , y ) = {T}_{B} \\ {I}_{high - brightness} , & B ( x , y ) > {T}_{B}\end{matrix} \qquad ( 6 )$$

where, B(x, y) is the brightness at pixel p(x, y) and T_{B} is a threshold brightness value. With the brightness criterion, the system can divide the image into three categories including low brightness image, normal brightness image, and high brightness image (operation 512).

For example, if B(x, y)<T_{B}, then the system classifies the image as a low brightness image 520. In this case, the image appears dark. It needs its brightness increased by a brightness enhancement procedure. If B(x, y)=T_{B}, then the system classifies the image as a normal brightness image 530. In this case, the image appears normal lightness and it does not need any adjustment in brightness. If B(x, y)>T_{B}, then the system classifies the image as a high brightness image 540. In this case, the image appears too bright. It needs its brightness reduced by a brightness enhancement procedure.

In another embodiment, the system may define the brightness criterion using two brightness thresholds—T_{B1}, T_{B2}—to set a range [T_{B1}, T_{B2}] of brightness that is considered normal. In this case the brightness criterion may be defined as follows:

$${I}_{i n} = \{ \begin{matrix}{I}_{low - brightness} , & B ( x , y ) < {T}_{B 1} \\ {I}_{normal - brightness} , & {T}_{B 1} \leq B ( x , y ) \leq {T}_{B 2} \\ {I}_{high - brightness} , & B ( x , y ) > {T}_{B 2}\end{matrix} \qquad ( 7 )$$

The blurriness map 502 may be computed as discussed above (e.g., as C). The system may create a blurriness criterion 503, used for classifying the image Iᵢₙ into a blurriness category, as follows:

$${I}_{in} = \{ \begin{matrix}{I}_{low - blurriness} , & C ( x , y ) < {T}_{C} \\ {I}_{normal - blurriness} , & C ( x , y ) = {T}_{C} \\ {I}_{high - blurriness} , & C ( x , y ) > {T}_{C}\end{matrix} \qquad ( 8 )$$

where, C(x, y) is the blurriness at pixel p(x, y) and T_{C} is a threshold blurriness value. With the blurriness criterion, the system can divide the image into three categories including low blurriness image (or high contrast image), normal blurriness image (or normal contrast image), and high blurriness image (or low contrast image) at operation 522.

For example, if C(x, y)<T_{C}, then the system classifies the image as a low blurriness image 523, 533, or 543 (depending on the brightness classification of the image from operation 512). In this case, the image appears overly sharp with overly high contrast. It needs contrast adjustment such as smoothing processing by a contrast enhancement procedure. If C(x, y)=T_{C}, then the system classifies the image as a normal blurriness image 524, 534, or 544 (depending on the brightness classification of the image from operation 512). In this case, the image appears normal blurriness and it does not need any adjustment in contrast. If C(x, y)>T_{C}, then the system classifies the image as a high blurriness image 525, 535, or 545 (depending on the brightness classification of the image from operation 512). In this case, the image appears too blurry with low contrast. It needs its blurriness reduced by a contrast enhancement procedure.

Similar to the brightness criterion, the system may define the blurriness criterion using two blurriness thresholds—T_{C1}, T_{C2}—to set a range [T_{C1}, T_{C2}] of blurriness that is considered normal. In this case the blurriness criterion may be defined as follows:

$${I}_{in} = \{ \begin{matrix}{I}_{low - blurriness} , & C ( x , y ) < {T}_{C 1} \\ {I}_{normal - blurriness} , & {T}_{C 1} \leq C ( x , y ) \leq {T}_{C 2} \\ {I}_{high - blurriness} , & C ( x , y ) > {T}_{C 2}\end{matrix} \qquad ( 9 )$$

By combining the brightness classification and the blurriness classification, the system divides the image into nine categories:
low brightness and low contrast image 523
low brightness and normal contrast image 524
low brightness and high contrast image 525
normal brightness and low contrast image 533
normal brightness and normal contrast image 534
normal brightness and high contrast image 535
high brightness and low contrast image 543
high brightness and normal contrast image 544
high brightness and high contrast image 545

Referring now to FIG. 5B, the process flow 500 also works with a model for image quality improvement (or image enhancement model) 510 and whole frame image parameters 507. In this example, image visual quality refers to image brightness and image blurriness (contrast), and the system may use the following model for image visual quality improvement:

$${I}_{dst} = ℱ ( α , β , {I}_{s r c} ) \qquad ( 10 )$$

where I_{dst} is the visual quality enhanced image, [symbol] (⋅) is an image enhancement function, α is the parameter for brightness control, and β is the parameter for contrast control.

In some embodiments, for the image enhancement function [symbol] (⋅) the system can use a Gamma function:

$${I}_{dst} = α {I}_{s r c}^{β} \qquad ( 11 )$$

where α is used for brightness control and β is used for contrast control.

In another embodiment, the system can use an affine function as [symbol] (⋅):

$${I}_{dst} = {aI}_{s r c} + b \qquad ( 12 )$$

where b is used for brightness control and a is used for contrast control.

The image quality parameters used in image quality improvement operations 550 include the image brightness map 504, image blurriness map 502, image SNR map 506, and the image parameters of the whole frame 507. The image parameters of the whole frame 507 include the image mean μ, standard deviation σ, and SNR, which can be used for computing parameters of the image enhancement model 510 and verifying the enhanced image quality. All of these parameters are adaptive parameters, as discussed above.

For each of the nine image quality categories defined above (523, 524, 525, 533, 534, 535, 543, 544, 545), the system may use different parameters for the image enhancement model 510 to heuristically improve image quality in operations 550. For example, the parameter α used for brightness control may be a function of the parameter β used for contrast control, the image mean μ, and the input image Iᵢₙ:

$$α = f ( μ , β , {I}_{i n} ) \qquad ( 13 )$$

For different image enhancement models 510, the system may determine the parameter α with different approaches at operation 511. For example, for Gamma function (11), α may be defined as:

$$α = \{ \begin{matrix}1 , & μ \geq {T}_{B 2} \\ \frac{1}{q ( β , {I}_{in} )} , & μ < {T}_{B 1}\end{matrix} \qquad ( 14 )$$

where μ is the image mean value, q(⋅) is a function of β and Iᵢₙ, and [T_{B1}, T_{B2}] is the range of normal brightness. For local (or regional) image enhancement, the system may compute the image mean value μ in the moving window W discussed with respect to FIG. 4.

Alternatively, for the affine function (12), the system may compute the image histogram and the cumulative distribution to obtain the pixel value range [symbol] (p(x, y)) and compute the parameters a and b with the pixel value range:

$$\{ \begin{matrix}a = g ( ℛ ( p ( x , y ) ) ) \\ b = h ( ℛ ( p ( x , y ) ) )\end{matrix} \qquad ( 15 )$$

Referring now to the image quality improvement operation 552 for the case of a low brightness and low contrast image 523, the image is a dark image with low brightness μ<T_{B1}. Following equation (14), the system may compute parameter α for brightness control as:

$$α = \frac{1}{q ( β , {I}_{i n} )} \qquad ( 16 )$$

This is a low contrast case. The system may compute parameter β for contrast control as:

$$β = L ( μ , σ ) \qquad ( 17 )$$

where μ is the image mean, σ is the image standard deviation, and L(⋅) is a logarithmic function such as log₂ x or log₁₀ x. So, in this case, the system may use the image enhancement model parameters:

$$\{ \begin{matrix}α = \frac{1}{q ( β , {I}_{i n} )} \\ β = L ( μ , σ )\end{matrix} \qquad ( 18 )$$

In the case of global image enhancement, the system may compute α and β for the whole frame image Iᵢₙ. In the case of local (regional) image enhancement, the system may compute α and β for the image in the moving window as discussed above, e.g.:

$${I}_{i n} ( ( x , y ) ∈ W ( x , y ) ) \qquad ( 19 )$$

where W(x, y) is a moving window.

Referring now to the image quality improvement operation 553 for the case of a low brightness and normal contrast image 524, the image is a dark image with low brightness μ<T_{B1}. This is similar to the case of a low brightness and low contrast image 523, and accordingly the system may compute parameter α for brightness control according to equation (16).

This is a low contrast case. Accordingly the system may use parameter β=1 for contrast control. So, in this case, the system may use the image enhancement model parameters:

$$\{ \begin{matrix}α = \frac{1}{q ( β , {I}_{i n} )} \\ β = 1\end{matrix} \qquad ( 20 )$$

In the case of global image enhancement, the system may compute α for the whole frame image Iᵢₙ. In the case of local (regional) image enhancement, the system may compute a for the image in the moving window as discussed above.

Referring now to the image quality improvement operation 554 for the case of a low brightness and high contrast image 525, the image is a dark image with low brightness μ<T_{B1}. This is similar to the case of a low brightness and low contrast image 523, and accordingly the system may compute parameter α for brightness control according to equation (16).

This is a high contrast case. The system may compute parameter β for contrast control as:

$$β = E ( μ , σ ) \qquad ( 21 )$$

where μ is the image mean, σ is the image standard deviation, and E(⋅) is an exponential function such as e^{x}. So, in this case, the system may use the image enhancement model parameters:

$$\{ \begin{matrix}α = \frac{1}{q ( β , {I}_{i n} )} \\ β = E ( μ , σ )\end{matrix} \qquad ( 22 )$$

In the case of global image enhancement, the system may compute α and β for the whole frame image Iᵢₙ. In the case of local (regional) image enhancement, the system may compute α and β for the image in the moving window as discussed above.

Referring now to the image quality improvement operation 555 for the case of a normal brightness and low contrast image 533, the image is a normal brightness image T_{B1}≤μ≤T_{B2}. The system does not need to adjust the brightness, and accordingly may use α=1 as the parameter for brightness control. On the other hand, the image is low contrast image. The system may compute parameter β for contrast control with a logarithmic function according to equation (17).

So, in this case, the system may use the image enhancement model parameters:

$$\{ \begin{matrix}α = 1 \\ β = L ( μ , σ )\end{matrix} \qquad ( 23 )$$

In the case of global image enhancement, the system may compute β for the whole frame image Iᵢₙ. In the case of local (regional) image enhancement, the system may compute β for the image in the moving window as discussed above.

Referring now to the image quality improvement operation 556 for the case of a normal brightness and normal contrast image 534, since the image has normal brightness T_{B1}≤μ≤T_{B2} and normal contrast. In this case, the system does not need to adjust the brightness or the contrast for the image. This may be represented by the following image enhancement model parameters even if image enhancement is not performed:

$$\{ \begin{matrix}α = 1 \\ β = 1\end{matrix} \qquad ( 24 )$$

Referring now to the image quality improvement operation 557 for the case of a normal brightness and high contrast image 535, the image has normal brightness T_{B1}≤μ≤T_{B2}. Accordingly, the system may use parameter α=1 for brightness. However, the image is a high contrast image. Accordingly, the system may compute parameter β for control contrast with an exponential function according to equation (21).

So, in this case, the system may use the image enhancement model parameters:

$$\{ \begin{matrix}α = 1 \\ β = E ( μ , σ )\end{matrix} \qquad ( 25 )$$

In the case of global image enhancement, the system may compute β for the whole frame image Iᵢₙ. In the case of local (regional) image enhancement, the system may compute β for the image in the moving window as discussed above.

Referring now to the image quality improvement operation 558 for the case of a high brightness and low contrast image 543, the image has high brightness μ>T_{B2}. Accordingly, the system may use parameter α=1 for brightness. However, the image is a low contrast image. Accordingly, the system may compute parameter β for control contrast with a logarithmic function according to equation (17).

So, in this case, the system may use the image enhancement model parameters:

$$\{ \begin{matrix}α = 1 \\ β = L ( μ , σ )\end{matrix} \qquad ( 26 )$$

In the case of global image enhancement, the system may compute β for the whole frame image Iᵢₙ. In the case of local (regional) image enhancement, the system may compute β for the image in the moving window as discussed above.

Referring now to the image quality improvement operation 559 for the case of a high brightness and normal contrast image 544, the image has high brightness μ>T_{B2}. Accordingly, the system may use parameter α=1 for brightness. The image is also normal contrast, so the system may use parameter β=1 for contrast control.

So, in this case, the system may use the image enhancement model parameters:

$$\{ \begin{matrix}α = 1 \\ β = 1\end{matrix} \qquad ( 27 )$$

Referring now to the image quality improvement operation 560 for the case of a high brightness and high contrast image 545, the image has high brightness μ>T_{B2}. Accordingly, the system may use parameter α=1 for brightness. On the other hand, the image is a high contrast image. Accordingly, the system may compute parameter β for control contrast with an exponential function according to equation (21).

So, in this case, the system may use the image enhancement model parameters:

$$\{ \begin{matrix}α = 1 \\ β = E ( μ , σ )\end{matrix} \qquad ( 28 )$$

In the case of global image enhancement, the system may compute β for the whole frame image Iᵢₙ. In the case of local (regional) image enhancement, the system may compute β for the image in the moving window as discussed above.

In the embodiments of the present disclosure provided above the system determines image quality features, classifies the images into proper categories based on the determined image quality features, and improves image quality with a Gamma correction model. These embodiments are merely one example, and may be extended. For example, other models may be used to improve the image quality according to the image quality category. In one such example, the system may create an affine correction model with computed parameters to improve the image quality. In other examples, the system may also create an image enhancement model with a camera response function and a brightness transform function for different image quality categories.

Additionally, in the embodiments of the present disclosure provided above the system classifies images into image categories of low brightness, normal brightness, and high brightness, low contrast, normal contrast, and high contrast. These embodiments are merely one example, and may be extended. For example, the system may create more detailed categories for image quality. In one such example, the system may create image categories of low brightness, medium-low brightness, normal brightness, medium-high brightness, and high brightness. Similar categories may be created for

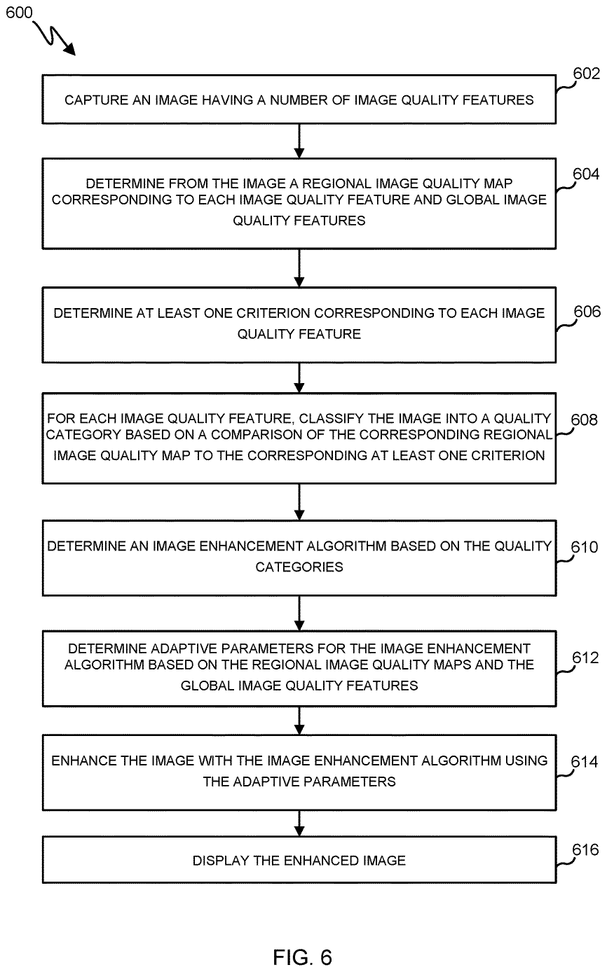

FIG. 6 illustrates an example method 600 for providing heuristic adaptive image quality detection and improvement for MR devices in accordance with this disclosure. For ease of explanation, the method 600 shown in FIG. 6 is described as being performed using the electronic device 101 in the network configuration 100 of FIG. 1, where the electronic device 101 can be an MR device. However, the method 600 could be performed using any other suitable device(s), such as the server 106, and in any other suitable system(s).

As shown in FIG. 6, the electronic device 101 captures an image with an external camera (step 602). The image has a number of image quality features, e.g., brightness, contrast, and SNR. The image may be, for example, a video see-through frame.

The device then determines from the image a regional image quality map corresponding to each image quality feature as well as global image quality features (step 604). For each image quality feature, determining the corresponding regional image quality map may comprise determining a regional image quality value for each pixel of the image as a function of pixel values of all pixels within a window centered on the pixel.

In some embodiments, the regional image quality maps may include a regional brightness map, a regional contrast map, and a regional SNR map. In such cases, the device may determine the regional brightness map by determining a regional brightness value for each pixel of the image as a mean of the pixel values of all pixels within the window. The device may also determine the regional contrast map by determining a regional contrast value for each pixel of the image as a standard deviation of the pixel values of all pixels within the window. The device may also determine the regional SNR map by determining a regional SNR value for each pixel of the image as a logarithmic function of the mean and the standard deviation of the pixel values of all pixels within the window.

In some embodiments, the device collects eye tracking data using eye tracking sensors, and determines a user foveation region within the image based on data from the eye tracking sensors. In such cases, the device may determine the regional image quality maps and the global image quality features based on the foveation region of the image. For example, the device may consider the foveation region to be the whole image for the purposes of the other steps of the method 600.

Next, the device determines at least one criterion corresponding to each image quality feature (step 606).

For each image quality feature, the device classifies the image into a quality category based on a comparison of the corresponding regional image quality map to the corresponding at least one criterion (step 608). This may include classifying the image into a brightness quality category, a contrast quality category, and an SNR quality category.

The device then determines an image enhancement algorithm based on the quality categories (step 610). In some cases, the image enhancement algorithm is determined based on the brightness quality category and the contrast quality category. The image enhancement algorithm may be, for example, a Gamma function or an affine function, in which case the adaptive parameters are parameters of the Gamma function or the affine function.

Next, the device determines adaptive parameters for the image enhancement algorithm based on the regional image quality maps and the global image quality features (step 612). These adaptive parameters may include a brightness control parameter and a contrast control parameter. In some embodiments, determining the adaptive parameters comprises selecting an algorithm for determining the brightness control parameter based on the brightness quality category and selecting an algorithm for determining the contrast control parameter based on the contrast quality category.

The device enhances the image with the image enhancement algorithm using the adaptive parameters at step 614. In some embodiments, step 614 additionally includes performing noise reduction based on the SNR quality category. The device may then perform pass-through transformation on the enhanced image to generate a pass-through image that matches a viewpoint of the user's eyes.

Finally, the device displays the enhanced image (or pass-through image) on, e.g., an MR display of the device (step 616).

Although FIG. 6 illustrates one example of a method 600 for providing heuristic adaptive image quality detection and improvement for MR devices, various changes may be made to FIG. 6. For example, while shown as a series of steps, various steps in FIG. 6 could overlap, occur in parallel, occur in a different order, or occur any number of times (including zero times).

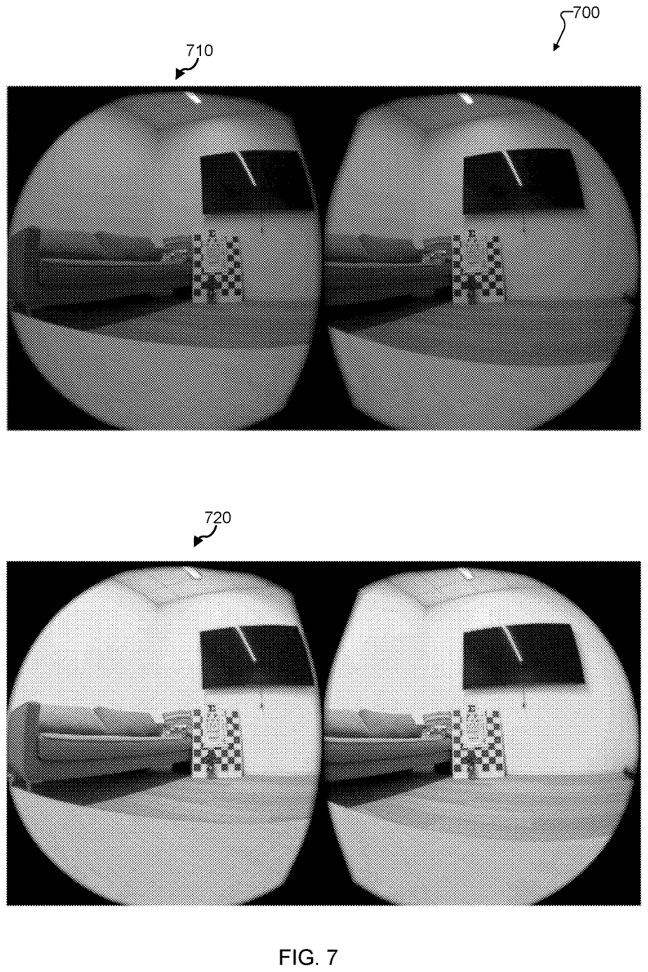

FIG. 7 illustrates a comparison 700 of VST image frames before and after heuristic adaptive image quality detection and improvement in accordance with this disclosure. Image 710 illustrates a pair of VST image frames as displayed on the binocular display of a VST MR HMD. No image quality enhancement has been performed on image 710. Image 710 has low brightness and contrast. Image 720 illustrates the same pair of VST image frames after enhancement using heuristic adaptive image quality detection and improvement embodiments of the present disclosure. Image 720 is brighter and has better contrast than image 710.

It should be noted that the functions shown in or described with respect to the figures can be implemented in an electronic device 101, 102, 104, server 106, or other device(s) in any suitable manner. For example, in some embodiments, at least some of the functions shown in or described with respect to the figures can be implemented or supported using one or more software applications or other software instructions that are executed by the processor 120 of the electronic device 101, 102, 104, server 106, or other device(s). In other embodiments, at least some of the functions shown in or described with respect to the figures can be implemented or supported using dedicated hardware components. In general, the functions shown in or described with respect to the figures can be performed using any suitable hardware or any suitable combination of hardware and software/firmware instructions. Also, the functions shown in or described with respect to the figures can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method performed by an electronic device, the method comprising:
capturing an image with an external camera of the device, the image having a number of image quality features;
determining from the image, using a processor of the device, a regional image quality map corresponding to each image quality feature and global image quality features;
determining, using the processor, at least one criterion corresponding to each image quality feature;
for each image quality feature, classifying, using the processor, the image into a quality category based on a comparison of the corresponding regional image quality map to the corresponding at least one criterion;
determining, using the processor, an image enhancement algorithm based on the quality categories;
determining, using the processor, adaptive parameters for the image enhancement algorithm based on the regional image quality maps and the global image quality features;
enhancing, using the processor, the image with the image enhancement algorithm using the adaptive parameters; and
displaying the enhanced image.

2. The method of claim 1, further comprising:
determining, using the processor, a user foveation region within the image based on data from eye tracking sensors of the device,
wherein the regional image quality maps and the global image quality features are determined from the foveation region of the image.

3. The method of claim 2, further comprising:
performing, using the processor, pass-through transformation on the enhanced image to generate a pass-through image that matches a viewpoint of the user's eyes,
wherein displaying the enhanced image comprises displaying the pass-through image.

4. The method of claim 1, wherein the image quality features include brightness, contrast, and signal-to-noise ratio (SNR).

5. The method of claim 4, wherein:
classifying the image into the quality category for each image quality feature comprises classifying the image into a brightness quality category, a contrast quality category, and an SNR quality category, and
the image enhancement algorithm is determined based on the brightness quality category and the contrast quality category.

6. The method of claim 5, wherein enhancing the image further comprises performing noise reduction based on the SNR quality category.

7. The method of claim 5, wherein:
the adaptive parameters include a brightness control parameter and a contrast control parameter, and
determining the adaptive parameters comprises selecting an algorithm for determining the brightness control parameter based on the brightness quality category and selecting an algorithm for determining the contrast control parameter based on the contrast quality category.

8. The method of claim 5, wherein:
the image enhancement algorithm is a Gamma function or an affine function, and
the adaptive parameters are parameters of the Gamma function or the affine function.

9. The method of claim 1, wherein for each image quality feature, determining the corresponding regional image quality map comprises determining a regional image quality value for each pixel of the image as a function of pixel values of all pixels within a window centered on the pixel.

10. The method of claim 9, wherein:
the regional image quality maps include a regional brightness map, a regional contrast map, and a regional SNR map,
determining the regional brightness map comprises determining a regional brightness value for each pixel of the image as a mean of the pixel values of all pixels within the window,
determining the regional contrast map comprises determining a regional contrast value for each pixel of the image as a standard deviation of the pixel values of all pixels within the window, and
determining the regional SNR map comprises determining a regional SNR value for each pixel of the image as a logarithmic function of the mean and the standard deviation of the pixel values of all pixels within the window.

11. An electronic device comprising:
an external camera configured to capture an image having a number of image quality features;
at least one display; and
a processor operably coupled to the external camera and the at least one display, the processor configured to:
determine from the image a regional image quality map corresponding to each image quality feature and global image quality features;
determine at least one criterion corresponding to each image quality feature;
for each image quality feature, classify the image into a quality category based on a comparison of the corresponding regional image quality map to the corresponding at least one criterion;
determine an image enhancement algorithm based on the quality categories;
determine adaptive parameters for the image enhancement algorithm based on the regional image quality maps and the global image quality features; and
enhance the image with the image enhancement algorithm using the adaptive parameters,
wherein the at least one display is configured to display the enhanced image.

12. The electronic device of claim 11, wherein:
the device further comprises eye tracking sensors operatively coupled to the processor,
the processor is further configured to determine a user foveation region within the image based on data from the eye tracking sensors, and
the regional image quality maps and the global image quality features are determined from the foveation region of the image.

13. The electronic device of claim 12, wherein:
the processor is further configured to perform pass-through transformation on the enhanced image to generate a pass-through image that matches a viewpoint of the user's eyes, and
the display is configured to display the pass-through image.

14. The electronic device of claim 11, wherein the image quality features include brightness, contrast, and signal-to-noise ratio (SNR).

15. The electronic device of claim 14, wherein:
the processor configured to classify the image into the quality category for each image quality feature is configured to classify the image into a brightness quality category, a contrast quality category, and an SNR quality category, and
the processor is configured to determine the image enhancement algorithm based on the brightness quality category and the contrast quality category.

16. The electronic device of claim 15, wherein the processor configured to enhance the image is further configured to perform noise reduction based on the SNR quality category.

17. The electronic device of claim 15, wherein:
the adaptive parameters include a brightness control parameter and a contrast control parameter, and
the processor configured to determine the adaptive parameters is configured to select an algorithm for determining the brightness control parameter based on the brightness quality category and to select an algorithm for determining the contrast control parameter based on the contrast quality category.

18. The electronic device of claim 15, wherein:
the image enhancement algorithm is a Gamma function or an affine function, and
the adaptive parameters are parameters of the Gamma function or the affine function.

19. The electronic device of claim 11, wherein for each image quality feature, the processor configured to determine the corresponding regional image quality map is configured to determine a regional image quality value for each pixel of the image as a function of pixel values of all pixels within a window centered on the pixel.

20. The electronic device of claim 19, wherein:
the regional image quality maps include a regional brightness map, a regional contrast map, and a regional SNR map,
the processor configured to determine the regional brightness map is configured to determine a regional brightness value for each pixel of the image as a mean of the pixel values of all pixels within the window,
the processor configured to determine the regional contrast map is configured to determine a regional contrast value for each pixel of the image as a standard deviation of the pixel values of all pixels within the window, and
the processor configured to determine the regional SNR map is configured to determine a regional SNR value for each pixel of the image as a logarithmic function of the mean and the standard deviation of the pixel values of all pixels within the window.
